(19) United States
(12) Patent Application Publication
(10) Pub. No.: US 2026/0061759 A1
(43) Pub. Date: Mar. 5, 2026

(54) IMAGE RECORDING APPARATUS

(71) Applicant: BROTHER KOGYO KABUSHIKI KAISHA, Nagoya (JP)

(72) Inventors: Satoru ARAKANE, Nagoya (JP); Tsuyoshi ITO, Nagoya (JP)

(21) Appl. No.: 19/304,934

(22) Filed: Aug. 20, 2025

(30) Foreign Application Priority Data
Aug. 29, 2024 (JP) 2024-147190

(51) Int. Cl. B41J 11/00; B41J 11/06; B41J 13/14; G06K 15/02; G06K 15/10

(52) U.S. Cl. CPC B41J 11/008; B41J 11/003; B41J 11/0065; B41J 11/0095; B41J 11/06; B41J 13/14; G06K 15/102; G06K 15/1843

(57) ABSTRACT

An image recording apparatus includes a platen, a recorder, and a controller. The platen includes ribs arranged at intervals in a first direction and protruding from a base. The platen supports a recording medium on at least a part of the ribs. The recorder is arranged to face the platen and records an image on the recording medium by causing a colorant to adhere to the recording medium. The controller controls the recorder to record a borderless image, in which no margin is reserved at least on a first end of the recording medium, by causing a portion of the colorant to adhere to the recording medium and another portion of the colorant to exceed in the first direction from the first end of the recording medium by a first length. The first length is a length corresponding to a size of the recording medium in the first direction.

### REFERENCE TO RELATED APPLICATIONS

This application claims priority from Japanese Patent Application No. 2024-147190, filed on Aug. 29, 2024. The entire content of the priority application is incorporated herein by reference.

### BACKGROUND ART

As an example of an image recording apparatus to record an image on a recording medium, a printer configured to record an image on a sheet by discharging ink onto the sheet is known.

### SUMMARY

The printer may record an image on a sheet based on data including information concerning, for example, a size of the sheet and whether the image is to be formed with or without borders. Depending on conditions whether the sheet size indicated in the data matches a sheet size instructed by a user, and whether the data indicates borderless or bordered recording, the printer may resize the image to be recorded and modify a manner of resizing to comply with the user's instruction. For example, for recording a borderless image on a sheet, the printer may resize the image such that leftward and rightward ends of the image are set at positions outside the leftward and rightward edges of the sheet.

Generally, such a known printer may record an image by discharging ink onto a sheet supported on a platen. The platen may include a base and a plurality of ribs aligned in one direction and protruding from the base. The sheet conveyed to the platen may contact the plurality of ribs to be supported on the platen. When the printer with the platen records a borderless and resized image on a sheet, without considering a positional relation between the ribs and the sheet, ink may adhere to the ribs on the platen if a distance between one of the ribs on the outside of the sheet and the edge of the sheet is small. The ink adhered to the ribs may stain a next sheet that is conveyed subsequently to the platen and contacts the ribs.

The present disclosure aims to provide an image recording apparatus capable of minimizing margin regions, where no colorants are applied, on edges of a recording medium in borderless printing and minimizing staining of ribs that may contact the recording medium.

According to an aspect of the present disclosure, an image recording apparatus includes a platen, a recorder, and a controller. The platen includes a base and a plurality of ribs arranged at intervals in a first direction and protruding from the base. The platen is configured to support a recording medium on at least a part of the plurality of ribs. The recorder is arranged to face the platen where the plurality of ribs protruding toward the recorder. The recorder is configured to record an image on the recording medium by causing a colorant to adhere to the recording medium supported by the platen. The controller is configured to control the recorder to record a borderless image, in which no margin is reserved at least on a first end of the recording medium, the first end being an end of the recording medium in the first direction, by causing a portion of the colorant to adhere to the recording medium and another portion of the colorant to exceed in the first direction from the first end of the recording medium by a first length. The first length is a length corresponding to a size of the recording medium in the first direction.

According to another aspect of the present disclosure, an image recording apparatus includes a platen, recorder, and a controller. The platen includes a base and a plurality of ribs arranged at intervals in a first direction and protruding from the base. The platen is configured to support a recording medium on at least a part of the plurality of ribs. The recorder is arranged to face the platen where the plurality of ribs protruding toward the recorder. The recorder is configured to record an image on the recording medium by causing a colorant to adhere to the recording medium supported by the platen. The controller is configured to control the recorder to record a borderless image, in which no margin is reserved at least on a first end of the recording medium, the first end being an end of the recording medium in the first direction, by causing a portion of the colorant to adhere to the recording medium and another portion of the colorant to exceed in the first direction from the first end of the recording medium, in a manner that varies according to a separation distance between a first rib being one of the plurality of ribs closest to the first end of the recording medium in the first direction and the first end of the recording medium.

### BRIEF DESCRIPTION OF DRAWINGS

FIG. 1 illustrates an overall configuration of a printer.

FIG. 2 is a top plan view of a carriage, a head, conveyer rollers, and a platen in the printer.

FIG. 3 is a front view of the carriage, head, and the platen in the printer.

FIG. 4 is a top plan view of a sheet cassette in the printer.

FIG. 5 is a block diagram illustrating an electrical configuration of the printer.

FIG. 6A is an illustrative view of a sheet in bordered recording. FIG. 6B is an illustrative view of a sheet in borderless recording. FIG. 6C is a flowchart illustrating a flow of steps in a process for recording an image.

FIG. 7A is an illustrative view of image data generated in borderless recording. FIG. 7B is a table associating sheet sizes with lengths WL, WR in borderless recording.

FIG. 8 is a flowchart illustrating a flow of steps in a process for recording an image.

FIG. 9A is a flowchart illustrating a flow of steps in a process for recording an image. FIG. 9B is an illustrative view of a discharging amount of ink to form dots that exceed leftward when a leftward separation distance is greater than or equal to a particular distance. FIG. 9C is an illustrative view of a discharging amount of ink to form dots that exceed leftward when the leftward separation distance is smaller than the particular distance. FIG. 9D is an illustrative view of a discharging amount of ink to form dots that exceed rightward when a rightward separation distance is greater than or equal to a particular distance. FIG. 9E is an illustrative view of a discharging amount of ink to form dots that exceed rightward when the rightward separation distance is smaller than the particular distance.

FIG. 10 is a flowchart illustrating a flow of steps in a process for borderless image recording when lengths WL, WR are determined each time the recording sheet is conveyed by a particular conveying amount according to positions of edges of a recording sheet.

FIG. 11 is a flowchart illustrating a flow of steps in a process for borderless image recording when lengths WL, WR are determined each time a particular number of recording passes are performed according to positions of edges of a recording sheet.

FIG. 12 is a top plan view of a sheet cassette in which one of locating members is movable.

### DESCRIPTION

### First Embodiment

Hereinafter, a first embodiment of the present disclosure will be described.

### Overall Configuration of Printer

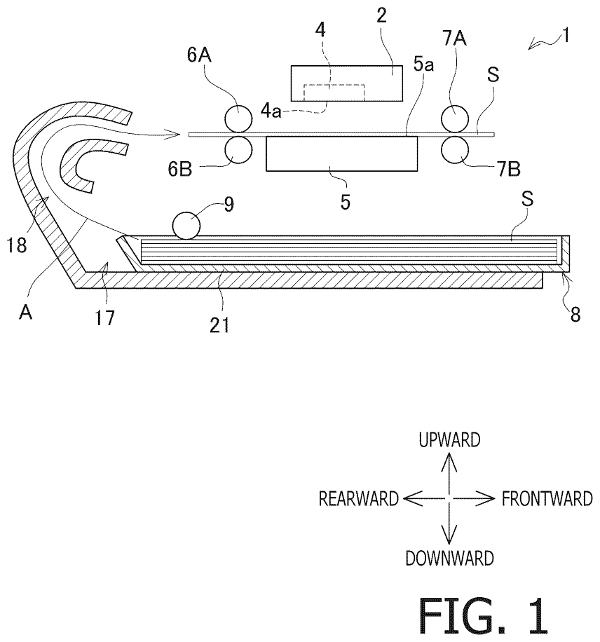

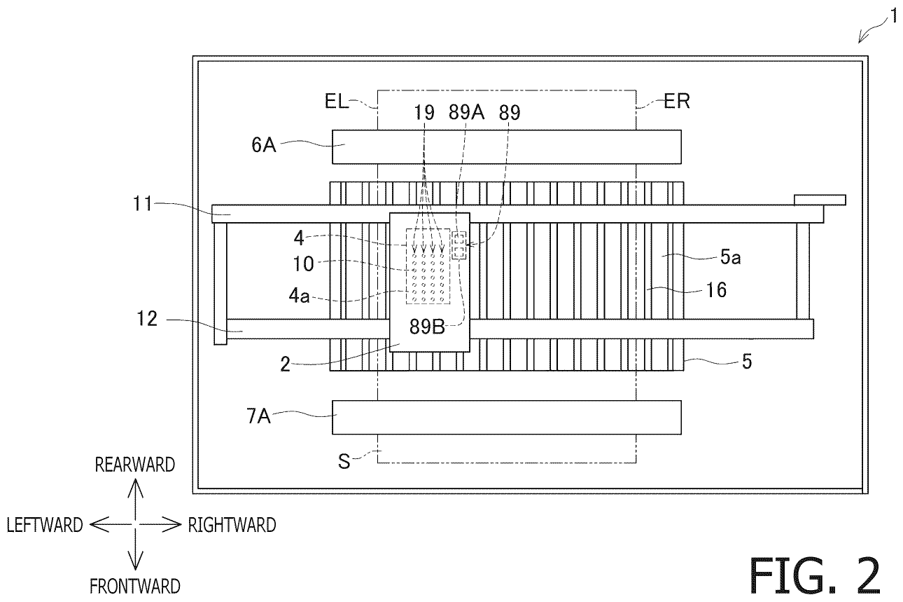

As shown in FIGS. 1 and 2, a printer 1 according to the first embodiment includes a carriage 2, a head 4, a platen 5, conveyer rollers 6A, 6B, 7A, 7B, a sheet cassette 8, and a feed roller 9. The printer 1 corresponds to the image recording apparatus according to the present disclosure.

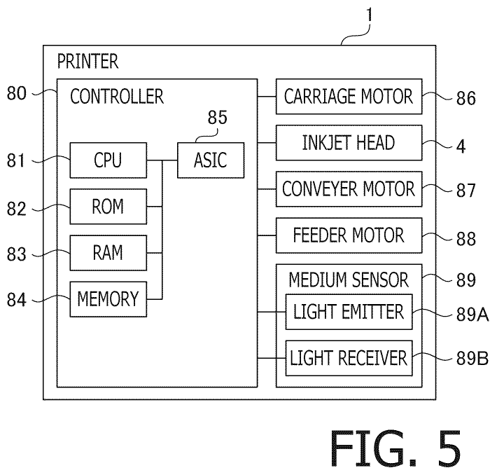

The carriage 2 is supported by two guide rails 11, 12, which extend in parallel to a leftward-rightward direction (FIG. 2) and are spaced apart from each other in a frontward-rearward direction (FIGS. 1 and 2). The carriage 2 is connected to a carriage motor 86 (see FIG. 5) via, for example, a belt (not shown). By driving the carriage motor 86, the carriage 2 is moved in leftward or rightward along the guide rails 11, 12. In the first embodiment, a leftward direction is a horizontal direction, and a rightward direction is another horizontal direction opposite to the leftward direction. In the first embodiment, a frontward direction is a horizontal direction intersecting both the leftward direction and the rightward direction orthogonally, and the rearward direction is another horizontal direction opposite to the frontward direction. In the first embodiment, the leftward direction corresponds to the first direction, the rightward direction corresponds to the second direction, and the frontward direction corresponds to the third direction.

The head 4 is mounted on the carriage 2. The head 4 is configured to discharge ink from a plurality of nozzles 10 formed on a nozzle surface 4a, which is a lower surface of the head 4. More specifically, the plurality of nozzles 10 are arranged in the frontward-rearward direction to form a nozzle row 19. The head 4 includes four nozzle rows 19 arrayed in the leftward-rightward direction. The nozzles 10 forming the nozzle rows 19, located from right to left, are configured to discharge ink in colors of black, yellow, cyan, and magenta, respectively. The head 4 is connected to four ink cartridges (not shown) via, for example, four tubes (not shown), and the ink in the four colors are supplied to the head 4 from the four ink cartridges. In the first embodiment, the head 4 corresponds to the recorder of the present disclosure. Moreover, in the first embodiment, the ink corresponds to the colorant of the present disclosure.

The platen 5 is disposed below the carriage 2 and the head 4. The platen 5 has a substantially rectangular parallelepiped shape. An upper surface of the platen 5 extends in the leftward-rightward direction and the frontward-rearward direction and forms a facing surface 5a that faces the nozzle surface 4a of the head 4. The platen 5 supports a recording sheet S from below. The recording sheet S supported by the platen 5 is located within a range in the leftward-rightward direction where the platen 5 is disposed, regardless of a size of the recording sheet S.

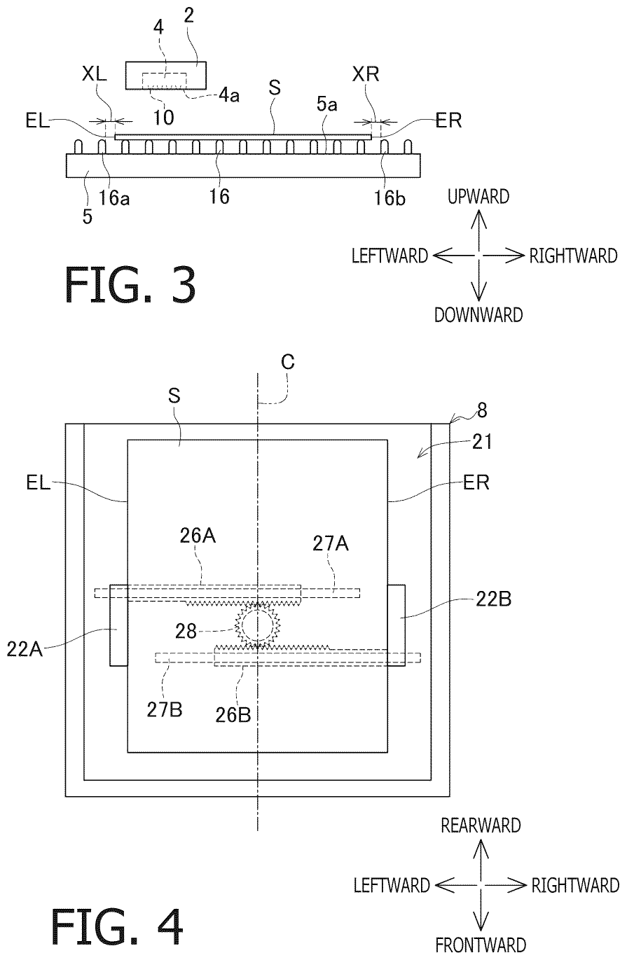

Details of the platen 5 for supporting the recording sheet S will be described below. As shown in FIG. 3, a plurality of ribs 16 are arranged on the facing surface 5a of the platen 5. The plurality of ribs 16 are arranged at intervals in the leftward-rightward direction and protrude upward from the facing surface 5a of the platen 5 toward the nozzle surface 4a of the head 4. The plurality of ribs 16 may be spaced apart from one another either evenly or at least partly unevenly. The recording sheet S is supported by the platen 5 by contacting upper ends of at least some of the plurality of ribs 16. The recording sheet S being supported on the ribs 16 as such may not contact the facing surface 5a of the platen 5.

The ribs 16 to contact the recording sheet S vary depending on a size of the recording sheet S in the leftward-rightward direction. Specifically, the ribs 16 to contact the recording sheet S vary depending on a position of a leftward end EL, which is an end of the recording sheet S in the leftward direction, and a position of a rightward end ER, which is an end of the recording sheet S in the rightward direction. In the first embodiment, the leftward end EL of the recording sheet S corresponds to the first end of the present disclosure, and the rightward end ER corresponds to the second end of the present disclosure.

The conveyer rollers 6A, 6B are disposed rearward with respect to the carriage 2, the head 4, and the platen 5. The conveyer rollers 6A, 6B are rollers, of which axes extend in a direction parallel to the leftward-rightward direction. The conveyer roller 6B is disposed below the conveyer roller 6A, and the recording sheet S may be nipped between the conveyer roller 6A and the conveyer roller 6B. The conveyer roller 6B is connected to a conveyer motor 87 shown in FIG. 5 via, for example, a gear (not shown). When the conveyer motor 87 is driven, the conveyer roller 6B rotates, and accordingly, the conveyer roller 6A is rotated. Thus, the recording sheet S nipped between the conveyer roller 6A and the conveyer roller 6B may be conveyed frontward.

The conveyer rollers 7A, 7B are disposed frontward with respect to the carriage 2, the head 4, and the platen 5. The conveyer rollers 7A, 7B are rollers, of which axes extend in a direction parallel to the leftward-rightward direction. The conveyer roller 7B is disposed below the conveyer roller 7A, and the recording sheet S may be nipped between the conveyer roller 7A and the conveyer roller 7B. The conveyer roller 7B is connected to the conveyer motor 87 shown in FIG. 5 via, for example, a gear (not shown). When the conveyer motor 87 is driven, the conveyer roller 7B rotates, and accordingly, the conveyer roller 7A is rotated. Thus, the recording sheet S nipped between the conveyer rollers 7A and the conveyer roller 7B may be conveyed frontward.

In the first embodiment, the conveyer rollers 6A, 6B, 7A, 7B correspond to the conveyer in the present disclosure.

The sheet cassette 8 is detachably attached to a cassette mounting section 17 below the platen 5 in the printer 1. As shown in FIGS. 1 and 4, the sheet cassette 8 includes a sheet storage 21, which is open upward. A plurality of recording sheets S may be stacked in the upward-downward direction to be stored in the sheet storage 21. In the sheet storage 21, locating members 22A, 22B are arranged. In the first embodiment, the locating member 22A and the locating member 22B correspond to the locating member in the present disclosure.

The locating member 22A extends in the frontward-rearward direction. The locating member 22A is configured to contact the leftward end EL of the recording sheet S stored in the sheet storage 21 to determine a position of the leftward end EL of the recording sheet S in the leftward-rightward direction. The locating member 22B is located rightward with respect to the locating member 22A and extends in the frontward-rearward direction. The locating member 22B is configured to contact the rightward end ER of the recording sheet S stored in the sheet storage 21 to determine a position of the rightward end ER of the recording sheet S in the leftward-rightward direction. The locating member 22A and the locating member 22B are movable leftward or rightward symmetrically with respect to a central axis C extending in the frontward-rearward direction, to fit with a size of the recording sheet S in the leftward-rightward direction stored in the sheet storage 21.

More specifically, the locating member 22A is connected to a rack gear 26A. The rack gear 26A is connected to a rearward end of the locating member 22A and extends rightward from the part where the rack gear 26A is connected with the locating member 22A. The locating member 22A and the rack gear 26A are movable leftward or rightward along a guide groove 27A extending in the leftward-rightward direction.

The locating member 22B is connected to a rack gear 26B. The rack gear 26B is connected to a frontward end of the locating member 22B and extends leftward from the part where the rack gear 26B is connected with the locating member 22B. The locating member 22B and the rack gear 26B are movable leftward or rightward along a guide groove 27B extending in the leftward-rightward direction.

Further, a pinion gear 28 is disposed between the rack gear 26A and the rack gear 26B in the frontward-rearward direction, and the pinion gear 28 meshes with the rack gears 26A, 26B.

With the above configuration, when a user moves the locating member 22A leftward, the rack gear 26A moves leftward together with the locating member 22A, causing the pinion gear 28 to rotate. Rotation of the pinion gear 28 causes the rack gear 26B to move rightward, and the locating member 22B moves rightward together with the rack gear 26B. Similarly, when the user moves the locating member 22A rightward, the locating member 22B moves leftward. Likewise, when the user moves the locating member 22B leftward, the locating member 22A moves rightward. Moreover, when the user moves the locating member 22B rightward, the locating member 22A moves leftward. In each of these cases, a moving amount of the locating member 22A is equal to a moving amount of the locating member 22B. As such, in the first embodiment, the locating member 22A and the locating member 22B are movable leftward or rightward symmetrically with respect to the central axis C.

By the locating member 22A and the locating member 22B being movable symmetrically with respect to the central axis C in the leftward-rightward direction, the recording sheet S, stored in the sheet storage 21 and located by the locating member 22A and the locating member 22B at a particular position, is set in an arrangement such that a position of the center thereof between the leftward end EL and the rightward end ER in the leftward-rightward direction is located at the same position, regardless of the size of the recording sheet S.

The feed roller 9 is arranged in the cassette mounting section 17. The feed roller 9 is urged downward by a spring (not shown), thereby being pressed against the recording sheet S stored in the sheet storage 21 of the sheet cassette 8. The feed roller 9 is connected to a feeder motor 88 shown in FIG. 5 via, for example, a gear (not shown). When the feeder motor 88 is driven, the feed roller 9 rotates and feeds a topmost recording sheet S among the plurality of recording sheets S stored in the sheet storage 21 rearward. The recording sheet S fed rearward by the feed roller 9 is conveyed along a feeder path 18 located rearward with respect to the feed roller 9, thereby changing the conveying direction thereof from rearward to frontward as indicated by an arrow A in FIG. 1, and is fed to the conveyer rollers 6A, 6B. The conveyer rollers 6A, 6B convey the recording sheet S fed in this manner frontward.

Further, in order to detect the recording sheet S fed by the feed roller 9 and conveyed by the conveyer rollers 6A, 6B as described above, a medium sensor 89 is arranged on the carriage 2. The medium sensor 89 includes a light emitter 89A and a light receiver 89B. The light emitter 89A and the light receiver 89B face the platen 5. The light emitter 89A emits light at the platen 5. The light receiver 89B receiving the light outputs a signal according to an amount of the received light.

In the present embodiment, a color of the recording sheet S is white, whereas a color of the platen 5 is black. When the recording sheet S is at a position on the platen 5 not facing the medium sensor 89, the light emitted from the light emitter 89A falls on the black platen 5 and is barely reflected. Therefore, under this condition, an amount of the light received by the light receiver 89B is below a threshold. When the recording sheet S is at a position on the platen 5 to face the medium sensor 89, the light emitted from the light emitter 89A falls on the white recording sheet S and is reflected. Therefore, under this condition, an amount of the light received by the light receiver 89B is equal to or greater than the threshold.

Thus, when the carriage 2 is located at a position where the medium sensor 89 faces a portion of the platen 5 overlapping the recording sheet S, the amount of light received by the light receiver 89B may shift from a value lower than the threshold to a value higher than or equal to the threshold. Based on the transition, the recording sheet S, fed by the feed roller 9 and conveyed by the conveyer rollers 6A, 6B, reaching the position on the platen 5 to face the medium sensor 89 may be detected.

### Electrical Configuration of the Printer

Next, an electrical configuration of the printer 1 will be described. As shown in FIG. 5, the printer 1 includes a controller 80. The controller 80 includes a CPU (Central Processing Unit) 81, a ROM (Read Only Memory) 82, a RAM (Random Access Memory) 83, a memory 84, and an Application Specific Integrated Circuit (ASIC) 85. The controller 80 controls operations involving the carriage motor 86, the head 4, the conveyer motor 87, the feeder motor 88, and the light emitter 89A in the medium sensor 89. The controller 80 may receive a signal from the light receiver 89B in the medium sensor 89.

Optionally, the controller 80 may be configured such that solely the CPU 81 performs processes, or solely the ASIC 85 performs the processes, or the CPU 81 and the ASIC 85 cooperate to perform the processes. Further, optionally, the controller 80 may include a single CPU 81 to perform the processes independently or include a plurality of CPUs 81 that share the processes. Furthermore, optionally, the controller 80 may include a single ASIC 85 or a plurality of ASICs 85 that share the processes.

### Control of Recording Operation

Next, processes to be executed by the controller 80 for recording an image on the recording sheet S in the printer 1 will be described.

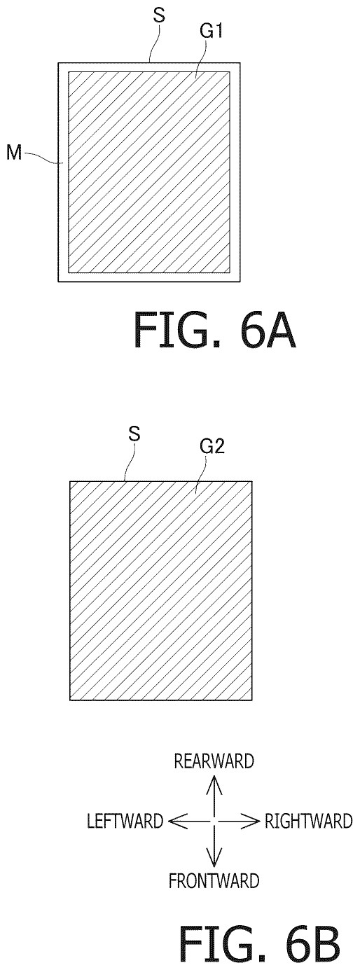

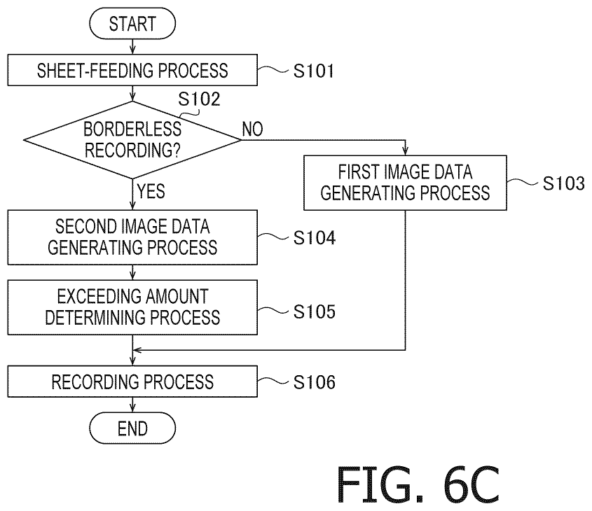

The printer 1 may perform bordered recording or borderless recording selectively. Bordered recording refers to recording of a bordered image, such as an image G1 shown in FIG. 6A, in which margins M are reserved along leftward, rightward, upward, and downward edges of the recording sheet S. Borderless recording refers to recording of a borderless image, such as an image G2 shown in FIG. 6B, in which no margin is reserved along the leftward, rightward, upward, or downward edges of the recording sheet S.

In the printer 1, the controller 80 may record an image on the recording sheet S by executing processes according to a flowchart shown in FIG. 6C. When the controller 80 receives a recording command that commands recording of an image on the recording sheet S, the controller 80 starts the flowchart in FIG. 6C. The recording command may be transmitted to the controller 80 based on an operation by a user using an operation device (not shown) of the printer 1, or may be transmitted from, for example, a PC or a smartphone (not shown) communicably connected to the printer 1. The recording command includes, for example, image data for the image to be recorded, sheet size information indicating a size of the recording sheet S, recording type information indicating whether bordered or borderless recording is to be performed.

The flowchart shown in FIG. 6C will be described below in detail. First, the controller 80 executes a sheet-feeding process (S101). In the sheet-feeding process in S101, the controller 80 controls the feeder motor 88 to operate the feed roller 9 to feed the recording sheet S from the sheet cassette 8, and controls the conveyer motor 87 to operate the conveyer rollers 6A, 6B to convey the recording sheet S being fed to the position detectable by the medium sensor 89.

Next, the controller 80 determines whether borderless recording is commanded based on the recording type information included in the recording command (S102). If borderless recording is commanded (S102: NO), the controller 80 executes a first image data generating process (S103). In the first image data generating process in S103, the controller 80 generates image data for an image G1 shown in FIG. 6A, which is an image enlarged or reduced from the image indicated by the image data included in the recording command. Thereafter, the controller 80 proceeds to a recording process in S106.

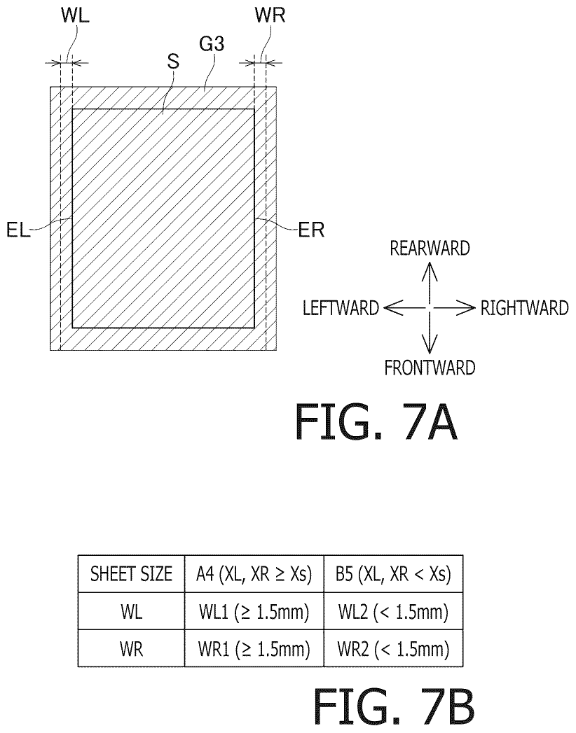

If borderless recording is commanded (S102: YES), the controller 80 executes a second image data generating process (S104). In the second image data generating process in S104, the controller 80 generates image data for an image G3, as shown in FIG. 7A, which is the image enlarged or reduced from the image indicated by the image data included in the recording command, exceeding the edges of the recording sheet S in the leftward, rightward, frontward, and rearward directions. In particular, the controller 80 generates image data for the image G3 enlarged or reduced at a particular fixed magnification regardless of a size of the recording sheet S.

Next, the controller 80 executes an exceeding amount determining process (S105), and proceeds to the recording process in S106. In the exceeding amount determining process in S105, for borderless recording, the controller 80 determines a length WL by which the ink exceeds leftward from the leftward end EL of the recording sheet S, and a length WR by which the ink exceeds rightward from the rightward end ER of the recording sheet S, in accordance with the size of the recording sheet S. In the first embodiment, the length WL corresponds to the first length of the present disclosure, and the length WR corresponds to the second length of the present disclosure.

Specifically, as shown in FIG. 7B, the memory 84 stores a table, in which sizes of the recording sheet S are associated with the length WL and the length WR. In the table in FIG. 7B, A4 size and B5 size of the recording sheet S are shown as examples of the sizes of the recording sheet S. In the example of FIG. 7B, the A4-sized recording sheet S corresponds to the first recording medium of the present disclosure, and the B5-sized recording sheet S corresponds to the second recording medium of the present disclosure.

In the first embodiment, as described above, the recording sheet S is set in the sheet storage 21 of the sheet cassette 8 such that the center between the leftward end EL and the rightward end ER in the leftward-rightward direction is located at the same position regardless of its size thereof. Accordingly, when the recording sheet S is fed by the feed roller 9 and conveyed by the conveyer rollers 6A, 6B, 7A, 7B, the center between the leftward end EL and the rightward end ER is maintained at the same position regardless of the size of the recording sheet S.

Therefore, depending on the size of the recording sheet S in the leftward-rightward direction, positions of the leftward end EL and the rightward end ER while recording an image may vary. As a result, depending on the size of the recording sheet S in the leftward-rightward direction, a separation distance XL between the leftward end EL of the recording sheet S and a first rib 16a located closest to the leftward end EL among the ribs 16 located leftward from the leftward end EL, and a separation distance XR between the rightward end ER of the recording sheet S and a second rib 16b located closest to the rightward end ER among the ribs 16 located rightward from the rightward end ER, as shown in FIG. 3, may also vary. FIG. 7B shows an example, in which the separation distances XL, XR are greater than or equal to a particular distance Xs when the recording sheet S is an A4-sized recording sheet S, and the separation distances XL, XR are less than the particular distance Xs when the recording sheet S is a B5-sized recording sheet S.

In FIG. 3, the second one of the ribs 16 from the left is shown as the first rib 16a, and the second one of the ribs 16 from the right is shown as the second rib 16b. The ribs 16 to serve as the first rib 16a and the second rib 16b among the plurality of ribs 16 depend on a size of the recording sheet S.

When the recording sheet S is an A4-sized recording sheet S and the separation distances XL, XR are greater than or equal to the particular distance Xs, in S104, the length WL is determined to be a length WL1, and the length WR is determined to be a length WR1. In the first embodiment, the lengths WL1, WR1 are lengths of 1.5 mm or greater. The length WL1 and the length WR1 may either be equal or different.

On the other hand, when the recording sheet S is a B5-sized recording sheet S and the separation distances XL, XR are less than particular distance Xs, in S104, the length WL is determined to be a length WL2, which is less than WL1, and the length WR is determined to be a length WR2, which is less than WR1. In the first embodiment, the lengths WL2, WR2 are lengths less than 1.5 mm. The length WL2 and the length WR2 may either be equal or different.

Note that, optionally, instead of the table that associates the sizes of the recording sheet S such as A4 size and B5 size with the lengths WL, WR shown in FIG. 7B, a table that associates the lengths of the recording sheet S in the leftward-rightward direction with the lengths WL, WR may be stored in the memory 84.

In the recording process in S106, the controller 80 controls the carriage motor 86, the head 4, and the conveyer motor 87 to record the image on the recording sheet S. More specifically, the controller 80 repeats a recording pass operation and a conveying operation. In the recording pass operation, the carriage motor 86 is controlled to move the carriage 2 leftward or rightward and the head 4 is controlled to discharge the ink from the plurality of nozzles 10 toward the recording sheet S so that the ink may be applied to and adhere to the recording sheet S. In the conveying operation, the conveyer motor 87 is controlled to operate the conveyer rollers 6A, 6B, 7A, 7B to convey the recording sheet S frontward. In the first embodiment, the recording pass operation corresponds to the adhesive operation of the present disclosure.

In the case where the image data was generated in the first image data generating process in S103, the controller 80 generates discharge data for discharging the ink from the plurality of nozzles 10 in the head 4 based on the image data generated in S103. On the other hand, in the case where the image data was generated in the second image data generating process in S104 and the lengths WL, WR were determined in the exceeding amount determining process in S105, the controller 80 generates discharge data based on a data portion corresponding to a region of the image G3 on the recording sheet S, a data portion corresponding to a region having the length WL adjacent leftward to the recording sheet S, and a data portion corresponding to a region having the length WR adjacent rightward to the recording sheet S, among the image data generated in S104. In other words, the discharge data is generated based on the data portions corresponding to the size of the recording sheet S in the leftward-rightward direction and the lengths WL, WR. Thereafter, when the controller 80 executes the recording pass operation, the controller 80 controls the head 4 to discharge the ink from the plurality of nozzles 10 based on the discharge data.

### Effects

The positional relation between the ribs 16 and the leftward and rightward ends EL, ER of the recording sheet S in the leftward-rightward direction varies depending on the size of the recording sheet S in the leftward-rightward direction. In the first embodiment, the recording sheet S is located at the particular position in the leftward-rightward direction by the locating member 22A and the locating member 22B such that the center between the leftward end EL and the rightward end ER of the recording sheet S in the leftward-rightward direction is always at the same position regardless of the size of the recording sheet S in the leftward-rightward direction. In this setting, the positions of the leftward end EL and the rightward end ER of the recording sheet S in the leftward-rightward direction during image recording vary depending on the size of the recording sheet S in the leftward-rightward direction. As a result, depending on the size of the recording sheet S in the leftward-rightward direction, the positional relation between the leftward and rightward ends EL, ER of the recording sheet S and the ribs 16 in the leftward-rightward direction during image recording changes, and the separation distances XL, XR change.

Therefore, if the lengths WL, WR in borderless recording are fixed regardless of the differences in the separation distances XL, XR caused by the differences in the sizes of the recording sheet S in the leftward-rightward direction, in other words, if the ink is discharged in the same manner regardless of the differences in the separation distances XL, XR, the ink exceeding the recording sheet S leftward or rightward tends to adhere to the ribs 16 depending on the size of the recording sheet S in the leftward-rightward direction. If the ink adheres to the ribs 16, for recording an image on a subsequent recording sheet S, the subsequent recording sheet S may contact the ribs 16, on which the ink remains, and the recording sheet S may be stained with the ink. On the other hand, for borderless recording, if the lengths WL, WR are determined to be greater, blank regions where the ink is absent along the edges on the leftward end EL and the rightward end ER of the recording sheet S may be reduced.

Therefore, in the first embodiment, for borderless recording, the ink is discharged onto the recording sheet S such that the lengths WL, WR correspond to the size of the recording sheet S in the leftward-rightward direction. In particular, for recording a borderless image on a recording sheet S of a size such that the separation distance XL is greater than or equal to the particular distance Xs, the length WL is set to WL1, but for recording a borderless image on a recording sheet S of a size such that the separation distance XL is less than the particular distance Xs, the length WL is set to a length WL2 which is less than WL1. Likewise, for recording a borderless image on a recording sheet S of a size such that the separation distance XR is greater than or equal to the particular distance Xs, the length WR is set to WR1, but for recording a borderless image on a recording sheet S of a size such that the separation distance XR is less than the particular distance Xs, the length WR is set to a length WR2 which is less than WR1. In other words, the manner to cause the ink to adhere to the recording sheet S is varied according to the separation distances XL, XR.

Therefore, when recording a borderless image, blank regions where the ink is absent on the edges along the leftward end EL and the rightward end ER of the recording sheet S may be minimized regardless of the size of the recording sheet S in the leftward-rightward direction. Meanwhile, the ink adhering to the ribs 16 may be reduced.

Moreover, in the first embodiment, for recording a borderless image, the ink is caused to exceed the leftward end EL to the left and the rightward end ER to the right, and as described above, the length WL is determined according to the separation distance XL, and the length WR is determined according to the separation distance XR. Accordingly, when recording a borderless image, blank regions where the ink is absent on the edges along both the leftward end EL and the rightward end ER may be minimized regardless of the size of the recording sheet S in the leftward-rightward direction. Meanwhile, the ribs 16 may prevent adhesion of the colorant.

In the first embodiment, for recording the borderless image, the lengths WL1, WR1 are set to 1.5 mm or more, and the lengths WL2, WR2 are set to less than 1.5 mm. Accordingly, when recording the borderless image, blank regions where the ink is absent on the edges along the leftward end EL and the rightward end ER may be minimized regardless of the size of the recording sheet S in the leftward-rightward direction. Meanwhile, the ribs 16 may prevent adhesion of the colorant.

Furthermore, in the first embodiment, for recording a borderless image, image data for an image that was enlarged or reduced by a particular fixed magnification regardless of the size of the recording sheet S in the leftward-rightward direction is generated, and the borderless image is recorded based on data portions of the generated image data that correspond to the size of the recording sheet S in the leftward-rightward direction and the lengths WL, WR. Accordingly, compared to a case where image data for an image that is enlarged or reduced by a different magnification based on the size of the recording sheet S in the leftward-rightward direction is generated, the process for generating the image data for borderless recording may be simplified.

### Second Embodiment

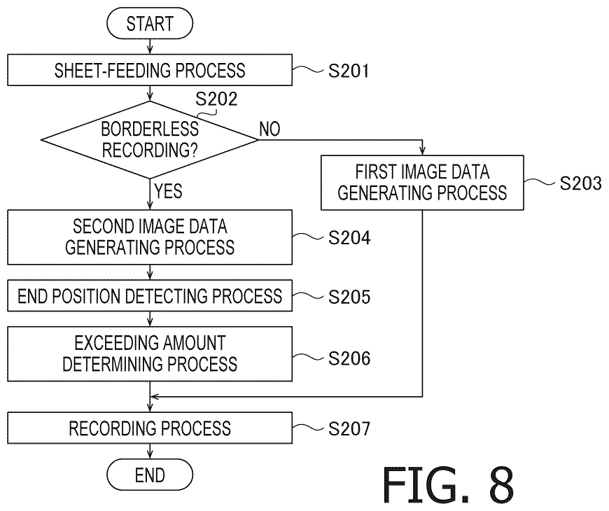

Next, a second embodiment of the present disclosure will be described below. The second embodiment also relates to the printer 1 similarly to the first embodiment. In the second embodiment, the controller 80 may record an image on the recording sheet S by executing processes according to a flowchart shown in FIG. 8.

The flowchart in FIG. 8 will now be described in detail. The controller 80 executes processes S201-S204, which are similar to S101-S104 in the flowchart of the first embodiment. After executing the second image data generating process in S203, the controller 80 executes an end position detecting process (S205).

In the end position detecting process in S205, the controller 80 detects positions of the leftward end EL and the rightward end ER of the recording sheet S using the medium sensor 89. The medium sensor 89 in the second embodiment corresponds to the end detector in the present disclosure.

A method for detecting the positions of the leftward end EL and the rightward end ER of the recording sheet S using the medium sensor 89 will be described in detail below. The controller 80 controls the light emitter 89A in the medium sensor 89 to emit light, and controls the carriage motor 86 to move the carriage 2 leftward over the entire length of the platen 5. The controller 80 may detect the position of the rightward end ER of the recording sheet S based on the position of the medium sensor 89 in the leftward-rightward direction when the amount of the light received by the light receiver 89B in the medium sensor 89 shifts from a value lower than the threshold to a value greater than or equal to the threshold. Further, the controller 80 may detect the position of the leftward end EL of the recording sheet S based on the position of the medium sensor 89 in the leftward-rightward direction when the amount of the light received by the light receiver 89B in the medium sensor 89 shifts from a value greater than or equal to the threshold to a value lower than the threshold.

For another example, the controller 80 may control the carriage motor 86 to move the carriage 2 rightward over the entire length of the platen 5 while the light emitter 89A in the medium sensor 89 emits light. In this case, the controller 80 may detect the position of the leftward end EL of the recording sheet S based on the position of the medium sensor 89 in the leftward-rightward direction when the amount of the light received by the light receiver 89B in the medium sensor 89 shifts from a value lower than the threshold to a value greater than or equal to the threshold. Further, the controller 80 may detect the position of the rightward end ER of the recording sheet S based on the position of the medium sensor 89 in the leftward-rightward direction when the amount of the light received by the light receiver 89B in the medium sensor 89 shifts from a value greater than or equal to the threshold to a value lower than the threshold.

Next, the controller 80 executes an exceeding amount determining process (S206). In the exceeding amount determining process in S206, the controller 80 determines the length WL based on the position of the leftward end EL of the recording sheet S detected in S205.

Moreover, in the exceeding amount determining process in S206, the controller 80 determines the length WR based on the position of the rightward end ER of the recording sheet S detected in S205.

Specifically, positions of the ribs 16 of the platen 5 in the leftward-rightward direction are stored in the memory 84. In the exceeding amount determining process in S206, the controller 80 calculates the separation distance XL based on the stored positions of the ribs 16 in the memory 84 and the position of the leftward end EL of the recording sheet S detected in S205. Further, the controller 80 determines the length WL by multiplying the calculated separation distance XL by a coefficient stored in advance in the memory 84. As such, the length WL is determined to be smaller as the calculated separation distance XL decreases.

Moreover, in the exceeding amount determining process in S206, the controller 80 calculates the separation distance XR based on the stored positions of the ribs 16 in the memory 84 and the position of the rightward end ER of the recording sheet S detected in S205. Further, the controller 80 determines the length WR by multiplying the calculated separation distance XR by a coefficient stored in advance in the memory 84. As such, the length WR is determined to be smaller as the calculated separation distance XR decreases. The coefficient for determining the length WL and the coefficient for determining the length WR may either be the same value or may be different values.

Next, the controller 80 executes a recording process (S207), which is similar to S106 in the first embodiment, after the first image data generating process in S203 and after the exceeding amount determining process in S206.

### Effects

As described above in the first embodiment, if the lengths WL, WR in borderless recording are fixed regardless of the separation distances XL, XR, the ink that exceeds leftward or rightward from the recording sheet S may tend to adhere to the rib 16 when the separation distances XL and XR are small. If the ink adheres to the ribs 16, for recording an image on a subsequent recording sheet S, the subsequent recording sheet S may may be stained with the ink. On the other hand, for borderless recording, if the lengths WL, WR are determined to be greater, blank regions where the ink is absent along the edges on the leftward end EL and the rightward end ER of the recording sheet S may be reduced.

Therefore, in the second embodiment, the positions of the leftward end EL and the rightward end ER of the recording sheet S in the leftward-rightward direction are detected, and the separation distances XL, XR are calculated based on the detected positions of the leftward end EL and the rightward end ER of the recording sheet S. Based on the calculated separation distances XL, XR, the lengths WL, WR are determined. In particular, the length WL is determined to be smaller as the calculated separation distance XL decreases, and the length WR is determined to be smaller as the calculated separation distance XR decreases.

Accordingly, when recording the borderless image, blank regions where the ink is absent on the edges along the leftward end EL and the rightward end ER may be minimized regardless of the size of the recording sheet S in the leftward-rightward direction. Meanwhile, the ink adhering to the ribs 16 may be reduced.

### Third Embodiment

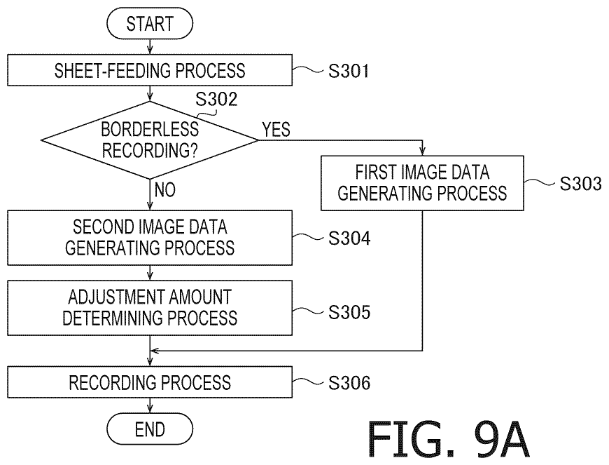

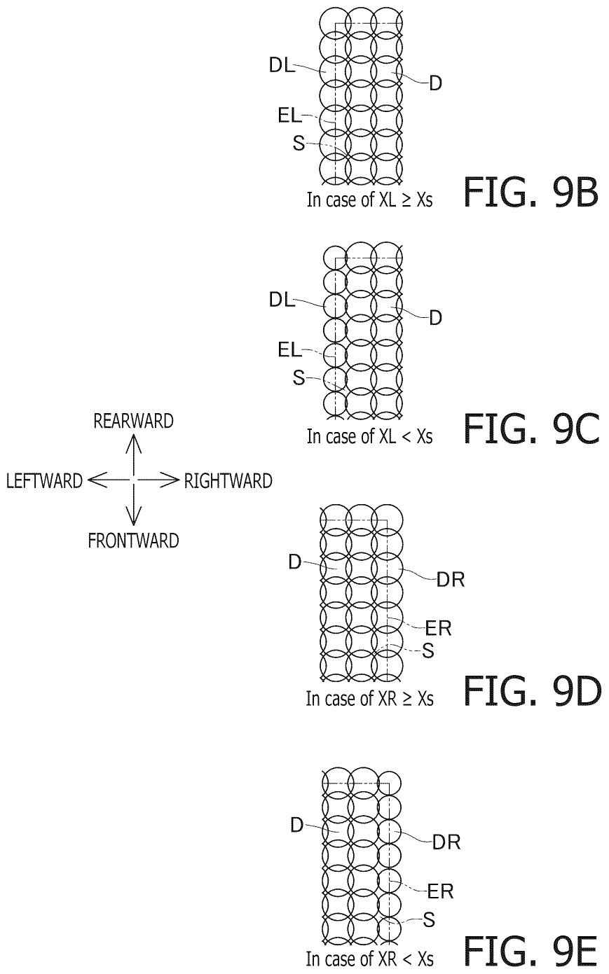

Next, a third embodiment of the present disclosure will be described below. The third embodiment relates to the printer 1 similarly to the first embodiment. In the third embodiment, the controller 80 may record an image on the recording sheet S by executing processes according to a flowchart shown in FIG. 9A.

The flowchart in FIG. 9A will be described below in detail. The controller 80 executes processes S301-S304, which are similar to S101-S104 in the flowchart of the first embodiment. Further, after executing the first image data generating process in S303, the controller 80 executes a recording process (S306), which is similar to S107 in the first embodiment.

Meanwhile, after the second image data generating process in S304, the controller 80 executes an adjustment amount determining process (S305). In the adjustment amount determining process in S305, the controller 80 determines an amount of adjustment to an ink discharging amount for forming a dot DL (see FIGS. 9B and 9C) that exceeds leftward from the leftward end EL of the recording sheet S, among a plurality of dots D forming the image, based on the separation distance XL. Moreover, in the adjustment amount determining process in S305, the controller 80 determines an amount of adjustment to an ink discharging amount for forming a dot DR (see FIGS. 9D and 9E) that exceed rightward from the rightward end ER of the recording sheet S, among the plurality of dots D forming the image, based on the separation distance XR.

Specifically, as shown in FIGS. 9B and 9C, when the separation distance XL is smaller than the particular distance Xs, the ink discharging amount for forming the dots DL is adjusted to be smaller than the amount when the separation distance XL is greater than or equal to the particular distance Xs. Note that FIGS. 9B and 9C show examples, where the ink discharging amounts for forming all of the dots DL are adjusted; however merely some of the ink discharging amounts for forming some of the dots DL may be adjusted.

Likewise, as shown in FIGS. 9D and 9E, when the separation distance XR is smaller than the particular distance Xs, the ink discharging amount for forming the dots DR is adjusted to be smaller than the amount when the separation distance XR is greater than or equal the particular distance Xs. Note that FIGS. 9D and 9E show examples, where the ink discharging amounts for forming all of the dots DR are adjusted; however merely some of the ink discharging amounts for forming some of the dots DR may be adjusted.

In this context, determining the amount of adjustment to the ink discharging amount may mean, for example, in a case where the head 4 is capable of changing the amount to discharge the ink from the nozzles 10 in multiple levels, determining the level of changing the amount from the amount indicated in the discharge data generated from the image data.

After the adjustment amount determining process in S305, the controller 80 executes the recording process (S306). For generating discharge data from the image data, the controller 80 generates the discharge data such that the ink discharging amounts for forming the dots DL, DR are adjusted based on the adjustment amounts determined in S305, with respect to the discharging amounts indicated in the discharge data generated from the image data.

### Effects

As described in the first embodiment above, if the ink is discharged in the same manner regardless of the differences in the separation distances XL, XR, the ink exceeding the recording sheet S leftward or rightward tends to adhere to the ribs 16 when a borderless image is recorded on the recording sheet S of which separation distances XL, XR are small. If the ink adheres to the ribs 16, for recording an image on a subsequent recording sheet S, the subsequent recording sheet S may be stained with the ink. On the other hand, for borderless recording, if the lengths WL, WR are determined to be greater, blank regions where the ink is absent along the edges on the leftward end EL and the rightward end ER of the recording sheet S may be reduced.

Therefore, in the third embodiment, for borderless recording, the manner to cause the ink to adhere to the recording sheet S is varied according to the separation distances XL, XR. In particular, for recording a borderless image on a recording sheet S with the separation distance XL being less than the particular distance Xs, the ink discharging amounts for forming the dots DL that exceed leftward the leftward end EL are reduced compared to the case where the separation distance XL is greater than or equal to the particular distance Xs. Likewise, for recording a borderless image on a recording sheet S with the separation distance XR being less than the particular distance Xs, the ink discharging amounts for forming the dots DR that exceed rightward the rightward end ER are reduced compared to the case where the separation distance XR is greater than or equal to the particular distance Xs.

Accordingly, when recording a borderless image, blank regions where the ink is absent on the edges along the leftward end EL and the rightward end ER of the recording sheet S may be minimized regardless of the size of the recording sheet S in the leftward-rightward direction. Meanwhile, the ink adhering to the ribs 16 may be reduced.

### Modified Examples

While the present disclosure described in conjunction with the example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential modifications according to aspects of the present disclosure are provided below.

For example, in the first embodiment, the lengths WL, WR when the separation distances XL, XR are greater than or equal to the particular distance Xs are determined to be the lengths WL1, WR1 which are 1.5 mm or greater, and lengths WL, WR when the separation distances XL, XR are less than the particular distance Xs are determined to be the lengths WL2, WR2 which are less than 1.5 mm. However, the settings of the lengths WR, WR are not necessarily limited to these: as long as the length WL2 is less than the length WL1, both the lengths WL1, WL2 may be 1.5 mm or more, or both the lengths WL1, WL2 may be less than 1.5 mm. Likewise, as long as the length WR2 is less than the length WR1, both the lengths WR1, WR2 may be 1.5 mm or more, or both the lengths WR1, WR2 may be less than 1.5 mm.

For another example, in the first embodiment, the table associating the lengths WL, WR with two sheet sizes of the recording sheet S is stored in memory 84; however, a table associating the lengths WL, WR with three or more sheet sizes of the recording sheet S may be stored in memory 84. In this case, the separation distances XL, XR for two or more sizes of the recording sheet S may be either equal to or greater than the particular distance Xs, or less than the particular distance Xs. Note that, among these recording sheets S in two or more different sizes, even if the separation distances XL, XR are different, the lengths WL, WR may be determined to be equal.

For another example, with regard to the first embodiment, the lengths WL, WR may not necessarily be determined to be one of the two lengths based on the condition whether the separation distances XL, XR according to the size of the recording sheet S are greater than or equal to the particular distance Xs or smaller than the particular distance Xs. For example, three or more ranges may be set to each of the separation distances XL, XR, and the lengths WL, WR may be determined to be one of three or more lengths depending on a range, within which the separation distances XL, XR fall, among the three or more ranges.

For another example, with regard to the second embodiment, the lengths WL, WR may not necessarily be determined such that the lengths WL, WR are smaller as the separation distances XL, WR decrease, by multiplying the separation distances XL, XR by a coefficient stored in the memory 84. For example, two or more ranges may be set to each of the separation distances XL, XR, and the lengths WL, WR may be determined to be one of two or more lengths depending on a range, within which the calculated separation distances XL, XR fall, among the two or more ranges. In this case, again, the lengths WL, WR are determined to be smaller when the separation distances XL, XR are smaller. Meanwhile, even in the case where the calculated separation distances XL, XR are different, the lengths WL, WR may be determined to be an equal length.

For another example, with regard to the third embodiment, the amounts of adjustment to the ink discharging amounts for the dots DL, DR may not necessarily be determined based on the condition whether the separation distances XL, XR are greater than or equal to the particular distance Xs or less than the particular distance Xs. For example, three or more ranges may be set to each of the separation distances XL, XR, and the adjustment amounts to the ink discharging amounts for forming the dots DL, DR may be determined to be one of three or more amounts depending on a range, within which the separation distances XL, XR fall, among the three or more ranges. For another example, in a case where the head 4 is capable of varying the amounts to discharge the ink from the nozzles 10 continuously, the adjustment amounts to the ink discharging amounts for forming the dots DL, DR may be determined by multiplying the separation distances XL, XR by a predefined coefficient.

For another example, with regard to the first embodiment, the length WL may not necessarily be determined based on the separation distance XL between the leftward end EL of the recording sheet S and one of the ribs 16 closest to the leftward end EL of the recording sheet S, or the length WR may not necessarily be determined based on the separation distance XR between the rightward end ER of the recording sheet S and one of the ribs 16 closest to the rightward end ER of the recording sheet S.

For example, in a case where the separation distance XL and the separation distance XR are substantially equal, such as a case where plurality of ribs 16 are arranged symmetrically in the leftward-rightward direction with respect to the center of the recording sheet S supported on the platen 5, both of the lengths WL, WR may be determined to be a same length corresponding to the separation distance XL or the separation distance XR.

For another example, the length WL may be a length corresponding to a separation distance between the leftward end EL of the recording sheet S and one of the ribs 16 located leftward from the leftward end EL of the recording sheet S other than the rib 16 closest to the leftward end EL of the recording sheet S, or the length WR may be a length corresponding to a separation distance between the rightward end ER of the recording sheet S and one of the ribs 16 located rightward from the rightward end ER of the recording sheet S other than the rib 16 closest to the rightward end ER of the recording sheet S.

For another example, in the second embodiment, the position of the leftward end EL of the recording sheet S is detected, and the length WL is determined to be a length corresponding to the separation distance XL, which is calculated based on the detected position of the leftward end EL, and the position of the rightward end ER of the recording sheet S is detected, and the length WR is determined to be a length corresponding to the separation distance XR, which is calculated based on the detected position of the rightward end ER. However, the lengths WL, WR may not necessarily be determined in this manner.

For example, in a case where the separation distance XL and the separation distance XR are substantially equal, such as a case where plurality of ribs 16 are arranged symmetrically in the leftward-rightward direction with respect to the center of the recording sheet S supported on the platen 5, a position of one of the leftward end EL or the rightward end ER of the recording sheet S may be detected, and the lengths WL, WR may be determined to be an equal length corresponding to the separation distance XL calculated based on the detected position of the leftward end EL or the separation distance XR calculated based on the detected position of the rightward end ER.

For another example, with regard to the second embodiment, the positions of the leftward end EL and the rightward end ER may not necessarily be determined solely once before the recording process starts or the lengths WL, WR may not necessarily be determined solely once before the recording process starts.

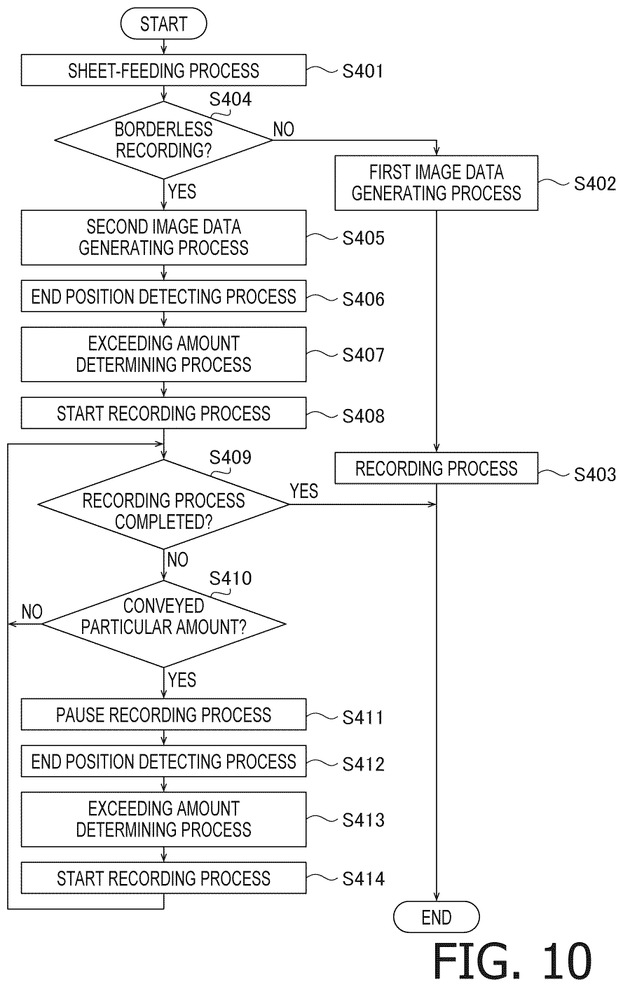

A first modified example will be described below. In the first modified example, the controller 80 may record an image on the recording sheet S by executing processes according to a flowchart shown in FIG. 10.

Specifically, the controller 80 executes processes S401, S402, and S404-S407, which are similar to S201-S206 in the flowchart of the second embodiment. After executing the first image data generating process in S402, the controller 80 executes a recording process (S403), which is similar to S207 in the second embodiment. The process ends thereafter.

On the other hand, after the exceeding amount determining process in S407, the controller 80 starts a recording process (S408). The recording process started in S408 is similar to the recording process in S403. Next, the controller 80 determines whether the recording process is completed (S409). If the recording process is completed (S409: YES), the process ends thereat.

If the recording process is not completed (S409: NO), the controller 80 determines whether the recording sheet S has been conveyed by a particular conveyance amount (S410). The particular conveyance amount may be an amount to be conveyed in a single conveying action or an amount to be conveyed in two or more conveying actions. For S410 in a first round after the recording process started, the controller 80 determines whether the recording sheet S has been conveyed by the particular conveyance amount from the start of the recording process. For S410 in a second round and onward, the controller 80 determines whether the recording sheet S has been conveyed by the particular conveyance amount from the point where the recording sheet S was conveyed by the particular amount in S410 in the previous round.

If the recording sheet S has not been conveyed by the particular conveyance amount (S410: NO), the controller 80 returns to S409. If the recording sheet S has been conveyed by the particular conveyance amount (S410: YES), the controller 80 pauses the recording process (S411). Next, the controller 80 executes an end position detecting process (S412), which is similar to S406, and an exceeding amount determining process (S413), which is similar to S407. Thereafter, the controller 80 resumes the recording process (S414) and returns to S409.

When a borderless image is recorded by repeating the recording pass operation and the conveying operation, the recording sheet S may deviate leftward or rightward due to an impact of the conveying operation. In the first modified example, each time the recording sheet S is conveyed by the particular conveyance amount, the controller 80 detects the positions of the leftward end EL and the rightward end ER of the recording sheet S. Based on the detected positions of the leftward end EL and the rightward end ER of the recording sheet S, the controller 80 calculates the separation distances XL, XR, and based on the calculated separation distances XL, XR, the controller 80 determines the lengths WL, WR. Accordingly, when recording the borderless image, blank regions where the ink is absent on the edges along the leftward end EL and the rightward end ER may be minimized regardless of the size of the recording sheet S in the leftward-rightward direction, while the ink adhering to the ribs 16 may be reduced.

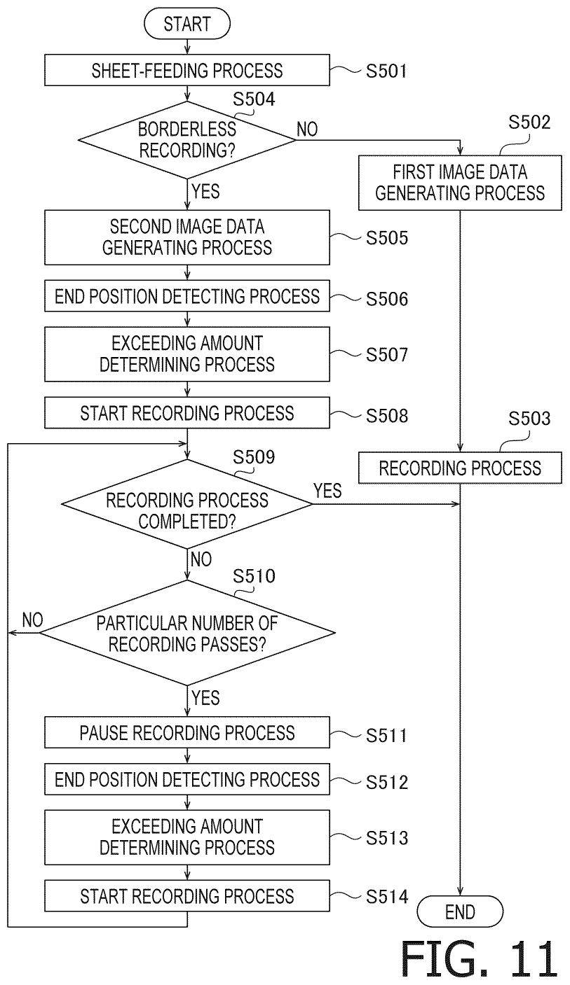

A second modified example will be described below. In the second modified example, the controller 80 may record an image on the recording sheet S by executing processes according to a flowchart shown in FIG. 11.

Specifically, the controller 80 executes processes S501-S508, which are similar to S401-S408 in the flowchart of the first modified example. In the second modified example, after starting the recording process in S508, the controller determines whether the recording process is completed (S509). If the recording process is completed (S509: YES), the process ends thereat.

If the recording process is not completed (S509: NO), the controller 80 determines whether a particular number of recording pass operations were performed (S510). The particular number may be one or more. For S510 in a first round after the recording process started, the controller 80 determines whether the particular number of recording pass operations were performed from the start of the recording process. For S510 in a second round and onward, the controller 80 determines whether the particular number of recording pass operations were performed from the point where the controller 80 determined that the particular number of recording pass operations were performed in S410 in the previous round.

If the particular number of recording pass operations were not performed (S510: NO), the controller 80 returns to S509. If the particular number of recording pass operations were performed (S510: YES), the controller 80 pauses the recording process (S511). Next, the controller 80 executes an end position detecting process (S512), which is similar to S506, and an exceeding amount determining process (S513), which is similar to S507. Thereafter, the controller 80 resumes the recording process (S514) and returns to S509.

When a borderless image is recorded by repeating the recording pass operation and the conveying operation, the recording sheet S may deviate leftward or rightward due to an impact of the conveying operation. In the second modified example, each time the particular number of recording pass operations are performed, the controller 80 detects the positions of the leftward end EL and the rightward end ER of the recording sheet S. Based on the detected positions of the leftward end EL and the rightward end ER of the recording sheet S, the controller 80 calculates the separation distances XL, XR, and based on the calculated separation distances XL, XR, the controller 80 determines the lengths WL, WR. Accordingly, when recording the borderless image, blank regions where the ink is absent on the edges along the leftward end EL and the rightward end ER may be minimized regardless of the size of the recording sheet S in the leftward-rightward direction, while the ink adhering to the ribs 16 may be reduced.

Note that, in the second image data generating process in the first through third embodiments described above, the image data for the image G3 may not necessarily be generated such that the image indicated by the image data included in the recording command is enlarged or reduced at the particular fixed magnification regardless of the size of the recording sheet S. For example, in the second image data generating process, image data for the image G3 may be generated such that the image indicated by the image data included in the recording command is enlarged or reduced at a different magnification depending on the size of the recording sheet S.

Furthermore, the recording sheet S stored in the sheet storage 21 of the sheet cassette 8 may not necessarily be set in the arrangement, as described above in the embodiments and the modified examples, such that the center between the leftward end EL and the rightward end ER in the leftward-rightward direction is located at the same position regardless of the size thereof.

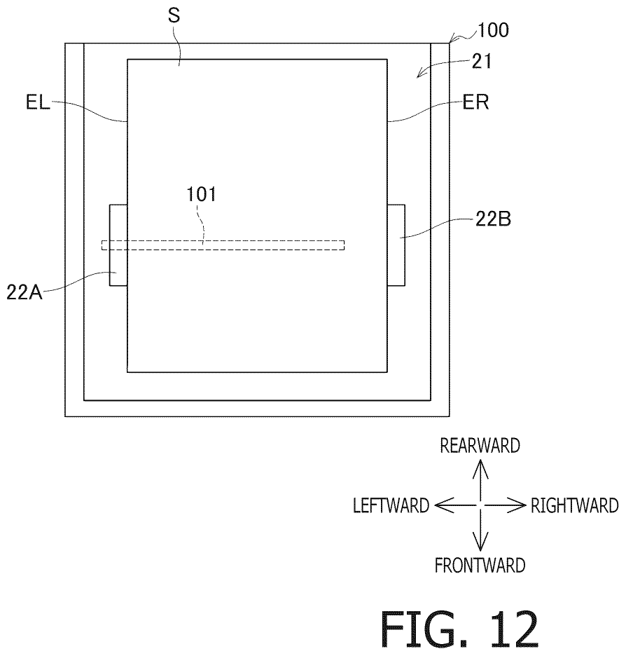

A third modified example will be described below. In the third modified example, as shown in FIG. 12, a sheet cassette 100 includes a sheet storage 21 and locating members 22A, 22B, which are similar to those in the sheet cassette 8 shown in FIG. 4.

However, the sheet cassette 100 differs from the sheet cassette 8 in the following respects. In the sheet cassette 100, the locating member 22A is movable leftward and rightward along a groove 101 that extends in the leftward-rightward direction according to the size of the recording sheet S. On the other hand, the locating member 22B is fixed to the sheet cassette 100 and is not movable in the leftward-rightward direction.

As such, in this sheet cassette 100, the locating member 22A is movable in the leftward-rightward direction while the locating member 22B is immovable in the leftward-rightward direction; therefore, the recording sheet S stored in the sheet storage 21 is set by the locating member 22A and the locating member 22B in an arrangement such that the position of the rightward end ER in the leftward-rightward direction is fixed regardless of the size of the recording sheet S.

With the sheet cassette 100 configured as above, in the third modified example, for borderless recording, a length, by which the ink exceeds leftward from the leftward end EL of the recording sheet S, or an amount of adjustment to the ink discharging amount for forming the dots DL that exceed leftward from the leftward end EL of the recording sheet S is determined based on the condition including the size of the recording sheet S and the separation distance XL, similarly to the length WL and the adjustment amount described above in the first through third embodiments. Further, for borderless recording, a length, by which the ink exceeds rightward from the rightward end ER of the recording sheet S, or an amount of adjustment to the ink discharging amount for forming the dots DR that exceed rightward from the rightward end ER of the recording sheet S are determined based on the condition including the size of the recording sheet S and the separation distance XR, similarly to the length WR and the adjustment amount described above in the first through third embodiments.

In the third modified example, the recording sheet S is located by the locating members 22A, 22B at the particular position in the leftward-rightward direction such that the rightward end ER of the recording sheet S is at the same position in the leftward-rightward direction regardless of the size of the recording sheet S in the leftward-rightward direction. In this case, the position of the leftward end EL of the recording sheet S in the leftward-rightward direction during image recording varies depending on the size of the recording sheet S in the leftward-rightward direction. Therefore, if the length WL in borderless recording is fixed regardless of the size of the recording sheet S in the leftward-rightward direction, depending on the size of the recording sheet S, the separation distance XL may be small, and the ink exceeding the recording sheet S leftward may easily adhere to the ribs 16.

Therefore, in the third modified example, for borderless recording, the controller 80 determines a length, by which the ink exceeds leftward from the leftward end EL of the recording sheet S, or an amount of adjustment to the ink discharging amount for forming the dots DL that exceed leftward from the leftward end EL of the recording sheet S are determined based on the size of the recording sheet S and the separation distance XL. Accordingly, when recording the borderless image, a blank region where the ink is absent on the edge along the leftward end EL may be minimized regardless of the size of the recording sheet S in the leftward-rightward direction while the ink adhering to the ribs 16 may be reduced.

In the third modified example, as described above, the position of the rightward end ER of the recording sheet S defined by the locating member 22A and the locating member 22B is fixed regardless of the size of the recording sheet S in the leftward-rightward direction. However, while the recording sheet S is being fed, the recording sheet S may deviate in the leftward-rightward direction, and the degree of deviation may vary depending on the size of the recording sheet S. Therefore, in the third modified example, for borderless recording, the controller 80 determines a length, by which the ink exceeds rightward from the rightward end ER of the recording sheet S, or an amount of adjustment to the ink discharging amount for forming the dots DR that exceed rightward from the rightward end ER of the recording sheet S are determined based on the size of the recording sheet S and the separation distance XR. Accordingly, when recording the borderless image, a blank region where the ink is absent on the edge along the rightward end ER may be minimized regardless of the size of the recording sheet S in the leftward-rightward direction while the ink adhering to the ribs 16 may be reduced.

Optionally, in the third modified example, the locating member 22A may be immovable in the leftward-rightward direction, and the locating member 22B may be movable in the leftward-rightward direction. In this arrangement, the recording sheet S, stored in the sheet storage 21 and located by the locating members 22A, 22B at a particular position, is located such that a position of the leftward end EL of the recording sheet S in the leftward-rightward direction is fixed, regardless of the size of the recording sheet S. Note that, in this arrangement, the rightward direction corresponds to the first direction of the present disclosure, and the leftward direction corresponds to the second direction of the present disclosure. Moreover, the rightward end ER of the recording sheet S corresponds to the first end of the present disclosure, and the leftward end EL corresponds to the second end of the present disclosure.

The embodiments and the modified examples described that the recording sheet S is fed from the sheet cassette, but the recording sheet S may not necessarily be fed from the sheet cassette. For example, the recording sheet S may be fed from a manual feeder tray disposed rearward with respect to the conveyer rollers 6A, 6B, and the user may insert the recording sheet S through manual feeder tray frontward to feed the recording sheet S.

The above embodiments and the modified examples showed cases, where both of the lengths WL, WR, by which the ink exceeds from the leftward end El and the rightward end ER of the recording sheet S, or amounts of adjustment to the ink discharging amounts for forming the dots DL, DR that exceed leftward and rightward from the leftward and rightward ends EL, ER of the recording sheet S are determined based on the size of the recording sheet S and the separation distances between one of the ribs 16 and the leftward end EL of the recording sheet S and between one of the ribs 16 and the rightward end ER of the recording sheet S. However, not both of the lengths WL, WR or the amounts of adjustment to the ink discharging amounts for forming the dots DL, DR may necessarily be determined. For example, solely one of the lengths WL, WR, by which the ink exceeds from the leftward or rightward end EL, ER of the recording sheet S, or amounts of adjustment to the ink discharging amounts for forming the dots DL, DR that exceed leftward or rightward from the leftward or rightward end EL, ER of the recording sheet S may be determined based on the size of the recording sheet S and the separation distance between one of the ribs 16 and the leftward end EL of the recording sheet S or between one of the ribs 16 and the rightward end ER of the recording sheet S.

Meanwhile, the above embodiments and modified examples do not explain ink that may exceed from a frontward end or rearward end of the recording sheet S during borderless recording. In this regard, for example, in the first or second embodiment, a length of the ink that may exceed from at least one of the frontward end or the rearward end of the recording sheet S may be determined for borderless recording according to the size of the recording sheet S in the frontward-rearward direction. For another example, in the first or second embodiment, a length of the ink that may exceed from the frontward end or the rearward end of the recording sheet S may be set to a fixed length regardless of the size of the recording sheet S in the frontward-rearward direction.

For another example, in the third embodiment, for at least one of the frontward end or the rearward end of the recording sheet S, an amount of adjustment to the ink discharging amount for forming the dots that may exceed frontward or rearward from the frontward end or the rearward end of the recording sheet S may be determined according to the size of the recording sheet S in the frontward-rearward direction. For another example, with regard to the third embodiment, for borderless recording, for at least one of the frontward end or the rearward end of the recording sheet S, an amount for forming the dots that exceed frontward or rearward from the frontward or rearward end of the recording sheet S regardless of the size of the recording sheet S in the frontward-rearward direction may not necessarily be adjusted according to the discharging amounts that are based on the image data.

For another example, the method to cause the ink to adhere to the recording sheet S differently may not necessarily be limited to varying the lengths of the ink to exceed from the ends of the recording sheet S or the amounts of adjustment to the ink discharging amounts for forming the dots that exceed from the ends of the recording sheet S based on the size of the recording sheet S or the separation distances between the ribs 16 and the ends of the recording sheet S. In other words, the ink may be caused to adhere to the recording sheet S differently by other method than varying the lengths of the ink to exceed from the ends of the recording sheet S or the amounts of adjustment to the ink discharging amounts for forming the dots that exceed from the ends of the recording sheet S.

For another example, the present disclosure may not necessarily be applied to an inkjet printer having a so-called serial printing head, which is configured to discharge ink from a plurality of nozzles while a head moves leftward or rightward along with a carriage. For example, the present disclosure may also be applied to an inkjet printer having a so-called line head extending in the leftward-rightward direction across an entire width of the platen 5. For another example, the present disclosure may be applied to a laser printer that may record an image by controlling a toner to adhere to a recording sheet. In this arrangement, the toner corresponds to the colorant of the present disclosure.

What is claimed is

1. An image recording apparatus, comprising:
a platen including a base and a plurality of ribs arranged at intervals in a first direction and protruding from the base, the platen being configured to support a recording medium on at least a part of the plurality of ribs;
a recorder arranged to face the platen where the plurality of ribs protruding toward the recorder, the recorder being configured to record an image on the recording medium by causing a colorant to adhere to the recording medium supported by the platen; and
a controller configured to control the recorder to record a borderless image, in which no margin is reserved at least on a first end of the recording medium, the first end being an end of the recording medium in the first direction, by causing a portion of the colorant to adhere to the recording medium and another portion of the colorant to exceed in the first direction from the first end of the recording medium by a first length, the first length being a length corresponding to a size of the recording medium in the first direction.

2. The image recording apparatus according to claim 1, further comprising:
a locating member configured to locate the recording medium at a particular position in the first direction, by contacting both the first end and a second end of the recording medium, the second end being an end of the recording medium in a second direction opposite to the first direction, the locating member being configured to locate the recording medium at the particular position in the first direction such that a center between the first end and the second end of the recording medium is located at the same position in the first direction regardless of the size of the recording medium in the first direction.

3. The image recording apparatus according to claim 1, further comprising:
a locating member configured to locate the recording medium at a particular position in the first direction, by contacting both the first end and a second end of the recording medium, the second end being an end of the recording medium in a second direction opposite to the first direction, the locating member being configured to locate the recording medium at the particular position in the first direction such that the second end of the recording medium is located at the same position in the second direction regardless of the size of the recording medium in the first direction.

4. The image recording apparatus according to claim 1, wherein
the first length corresponds to a separation distance between a first rib being one of the plurality of ribs closest to the first end of the recording medium in the first direction and the first end of the recording medium.

5. The image recording apparatus according to claim 4, wherein
the controller is configured to control the recorder to record the borderless image, in which no margin is reserved on a second end of the recording medium, the second end being an end of the recording medium in a second direction opposite to the first direction, by causing the portion of the colorant to adhere to the recording medium and another portion of the colorant to exceed in the second direction from the second end of the recording medium by a second length, the second length being a length corresponding to the size of the recording medium in the first direction,
the first length corresponds to a separation distance between a first rib being one of the plurality of ribs closest to the first end of the recording medium in the first direction and the first end of the recording medium, and
the second length corresponds to a separation distance between a second rib being one of the plurality of ribs closest to the second end of the recording medium in the second direction and the second end of the recording medium.

6. The image recording apparatus according to claim 4, further comprising an end detector configured to detect at least one of a position of the first end of the recording medium or a position of a second end being an end of the recording medium in a second direction opposite to the first direction,
wherein the controller is configured to:
based on the detected position of the at least one of the first end or the second end of the recording medium, calculate at least one of the separation distance between the first rib and the first end of the recording medium or the separation distance between the second rib and the second end of the recording medium; and
determine the first length based on the calculated at least one of the separation distances.

7. The image recording apparatus according to claim 6, wherein the controller is configured to determine the first length such that the first length decreases as the calculated at least one of the separation distances decreases.

8. The image recording apparatus according to claim 6, further comprising a conveyer configured to convey the recording medium in a third direction, the third direction intersecting the first direction orthogonally, wherein
the controller is configured to record the image on the recording medium by repeating an adhesive operation, in which the controller controls the recorder to cause the colorant to adhere to the recording medium, and a conveying operation, in which the controller controls the conveyer to convey the recording medium in the third direction,
the controller is configured to, for recording the borderless image on the recording medium:
control the end detector to detect the at least one of the position of the first end or the position of the second end of the recording medium each time the adhesive operation is repeated a particular number of times,
calculate the at least one of the separation distances based on the detected at least one of the position of the first end or the position of the second end of the recording medium, and
determine the first length based on the calculated at least one of the separation distances.

9. The image recording apparatus according to claim 4, wherein
the recording medium includes a first recording medium and a second recording medium having different sizes in the first direction,
the controller is capable of controlling the recorder to record the borderless image on the first recording medium and the borderless image on the second recording medium of which separation distance is different from the separation distance of the first recording medium, and
the first length is determined differently between a case where the borderless image is recorded on the first recording medium and a case where the borderless image is recorded on the second recording medium.

10. The image recording apparatus according to claim 9, wherein
the separation distance between the first rib being one of the plurality of ribs closest to the first end of the first recording medium in the first direction and the first end of the first recording medium is greater than or equal to the particular distance,
the separation distance between the first rib being one of the plurality of ribs closest to the first end of the second recording medium in the first direction and the first end of the second recording medium is smaller than the particular distance, and
the first length corresponding to the size of the second recording medium for recording the borderless image on the second recording medium is smaller than the first length corresponding to the size of the first recording medium for recording the borderless image on the first recording medium.

11. The image recording medium according to claim 10, wherein
the first length for recording the borderless image on the first recording medium is greater than or equal to 1.5 mm, and
the first length for recording the borderless image on the second recording medium is less than 1.5 mm.

12. The image recording medium according to claim 6, further comprising a conveyer configured to convey the recording medium in a third direction, the third direction intersecting the first direction orthogonally, wherein
the controller is configured to record the image on the recording medium by repeating an adhesive operation, in which the controller controls the recorder to cause the colorant to adhere to the recording medium, and a conveying operation, in which the controller controls the conveyer to convey the recording medium in the third direction,
the controller is configured to, for recording the borderless image on the recording medium:
control the end detector to detect the at least one of the position of the first end or the position of the second end of the recording medium each time the conveyer conveys the recording medium by a particular conveying distance,
calculate the at least one of the separation distances based on the detected at least one of the position of the first end or the position of the second end of the recording medium, and
determine the first length based on the calculated at least one of the separation distances.

13. The image recording apparatus according to claim 1, wherein the controller is configured to, for recording the borderless image:
generate image data for the image, the image being enlarged or reduced at a particular magnification regardless of the size of the recording medium in the first direction from an original image commanded to be recorded, and
control the recorder to cause the colorant to adhere to the recording medium based on the size of the recording medium in the first direction and a portion of the image data corresponding to the first length among the generated image data.

14. An image recording apparatus, comprising:
a platen including a base and a plurality of ribs arranged at intervals in a first direction and protruding from the base, the platen being configured to support a recording medium on at least a part of the plurality of ribs;
a recorder arranged to face the platen where the plurality of ribs protruding toward the recorder, the recorder being configured to record an image on the recording medium by causing a colorant to adhere to the recording medium supported by the platen; and
a controller configured to control the recorder to record a borderless image, in which no margin is reserved at least on a first end of the recording medium, the first end being an end of the recording medium in the first direction, by causing a portion of the colorant to adhere to the recording medium and another portion of the colorant to exceed in the first direction from the first end of the recording medium, in a manner that varies according to a separation distance between a first rib being one of the plurality of ribs closest to the first end of the recording medium in the first direction and the first end of the recording medium.

15. The image recording apparatus according to claim 14, wherein
the recording medium includes a first recording medium and a second recording medium having different sizes in the first direction,
the controller is capable of controlling the recorder to record the borderless image on the first recording medium, of which separation distance between the first rib being one of the plurality of ribs closest to the first end of the first recording medium in the first direction and the first end of the first recording medium is greater than or equal to a particular distance, and the borderless image on the second recording medium, of which separation distance between the first rib being one of the plurality of ribs closest to the first end of the second recording medium in the first direction and the first end of the second recording medium is smaller than the particular distance,
for recording the borderless image on the second recording medium, the controller is configured to control the recorder to cause the portion of the colorant that exceeds in the first direction from the first end of the second recording medium to be less than the portion of the colorant that exceeds in the first direction from the first end of the recording medium for recording the borderless image on the first recording medium.

16. The image recording apparatus according to claim 14, wherein
the recording medium includes a first recording medium and a second recording medium having different sizes in the first direction,
the controller is capable of controlling the recorder to record the borderless image on the first recording medium, of which separation distance between the first rib being one of the plurality of ribs closest to the first end of the first recording medium in the first direction and the first end of the first recording medium is greater than or equal to a particular distance, and the borderless image on the second recording medium, of which separation distance between the first rib being one of the plurality of ribs closest to the first end of the second recording medium in the first direction and the first end of the second recording medium is smaller than the particular distance,
for recording the borderless image on the second recording medium, the controller is configured to control the recorder to cause the portion of the colorant to exceed in the first direction from the first end of the second recording medium by a length, the length being smaller than a length by which the portion of the colorant is caused to exceed in the first direction from the first end of the first recording medium for recording the borderless image on the first recording medium.
